(19) United States
(12) Patent Application Publication
(10) Pub. No.: US 2006/0237950 A1
(43) Pub. Date: Oct. 26, 2006

(54) Apparatus and method for attaching a side airbag

(76) Inventors: Barry C. Worrell, Centerville, OH (US); Michael L. Wilcox, Bellbrook, OH (US); Kevin B. Kelly, Covington, OH (US); Timothy A. Fosberg, Medway, OH (US)

Correspondence Address: DELPHI TECHNOLOGIES, INC., M/C 480-410-202, PO BOX 5052, TROY, MI, 48007, US

(21) Appl. No.: 11/332,520

(22) Filed: Jan. 13, 2006

Related U.S. Application Data
(60) Provisional application No. 60/644,205, filed on Jan. 14, 2005.

(51) Int. Cl. B60R 21/213; B60R 21/217

(52) U.S. Cl. 280/728.2; 280/730.2

(57) ABSTRACT

An apparatus for attaching an inflatable cushion or vehicle trim portion to a vehicle. The apparatus comprising: a first means for engaging a portion of the inflatable cushion; a second means for engaging a portion of the vehicle, the second means being coupled to the first means, wherein the second means terminates in an engagement end, the engagement end being configured to slidably engage an opening in the vehicle.

### CROSS REFERENCE TO RELATED APPLICATIONS

This application claims the benefit of U.S. Provisional Patent Application Ser. No. 60/644,205 filed Jan. 14, 2005, the contents of which are incorporated herein by reference thereto.

### TECHNICAL FIELD

The present application relates to side airbag devices and more particularly the present application relates to an apparatus and method for attaching a side-curtain inflatable cushion or other vehicle components to a vehicle surface.

### BACKGROUND

Vehicles are supplied with side airbag devices. Generally, the device is located along a side of the vehicle in an un-inflated state and upon activation deploys an inflatable curtain in accordance with a predetermined activation event. Side impact air bags or inflatable cushions are often mounted in close proximity to the vehicle's roof rail, doorframe or center pillars, or in some instances within the side door. Accordingly, the space or housing for the un-inflated airbag is compact and extends or traverses along the window area or frame, as the airbag cannot be installed in the areas comprising the window. Moreover, it is also desirable to have the inflatable cushion disposed behind a decorative trim portion of the vehicle's interior. Thus, the presence of the side airbag device is not observable to occupants when it is in its un-deployed state.

Roof rails in today's vehicles fit in very tight packaging and are difficult to assemble items thereto. The traditional approach for assembling items to the roof rails is to bring a tool within the vehicle interior and drive a fastener in the body sheet metal. However, the approach is un-desirable from an ergonomic standpoint as the tool and the installer must enter into the vehicle interior wherein unintentional damage to the vehicle interior may occur.

When the air bag or inflatable cushion is mounted to the vehicle a top edge portion or a plurality of mounting portions of the top edge portion are fixed to the vehicle and a lower edge portion, which defines the bottom periphery of the airbag, deploys out of the storage area or location. Thus, the extended length of the top edge portion must be secured to the vehicle. Moreover and as discussed above, the securement of the top edge portion must occur in a relatively small location and during the installation sequence of the inflatable cushion. In addition, the folded or un-inflated cushion may be disposed directly in front of or on top of the mounting portion of the inflatable cushion thus, securing these inflatable cushions is cumbersome and sometimes labor intensive as there typically is a small mounting surface to which the inflatable cushion must be secured.

Accordingly, it is desirable to provide a method and apparatus for quickly and rigidly securing portions of a side-airbag cushion or other vehicle components (e.g., an interior trim portion) to a portion of the vehicle. In particular, it is desirable to provide a method and apparatus for providing ease of securement in small compact areas wherein the uninflated cushion is located and the installer may not be able to visually view the mounting location of the inflatable cushion. Furthermore, it is also desirable to provide an apparatus for securing the side air bag or other vehicle components without requiring a tool that must be used within the vehicle interior.

### SUMMARY OF THE INVENTION

This disclosure relates to a method and apparatus for attaching a side inflatable cushion or other vehicle components to a vehicle mounting surface.

An apparatus for attaching an inflatable cushion to a vehicle, comprising: a first portion; a second portion coupled to the first portion, the second portion being in a facing spaced relationship with respect to the first portion; and an engagement tab depending away from the second portion towards the first portion, wherein the second portion terminates in an engagement end, the engagement end having a protrusion located in an opening of the first portion.

An attaching assembly for attaching an inflatable cushion to a vehicle, comprising: an attachment clip for attaching the inflatable cushion to a mounting surface of the vehicle, the attachment clip comprising a first portion secured to a mounting portion of the inflatable cushion; a second portion, the second portion being in a facing spaced relationship with respect to the first portion; an engagement tab depending away from the second portion, wherein the second portion terminates in an engagement end, the engagement end having a protrusion located in an opening of the first portion; and wherein the protrusion is configured to engage an opening in the mounting surface and the engagement tab is configured to engage another opening in the mounting surface.

An apparatus for attaching an inflatable cushion to a vehicle, comprising: a first engagement portion coupled to a second engagement portion by a connecting member, wherein the first engagement portion is disposed in a facing spaced relationship with respect to the second engagement portion, wherein the first engagement portion is smaller than the second engagement portion; and a locking member depending laterally away from the second engagement member.

An attachment clip for attaching an inflatable cushion to a vehicle, the attachment clip comprising: a first outer portion; a second outer portion; an intermediate portion coupled to and disposed between the first outer portion and the second outer portion, wherein the first outer portion is in a facing spaced relationship with respect to the intermediate portion and the second outer portion is also in a facing spaced relationship with respect to the intermediate portion; and an engagement tab depending away from the first outer portion the engagement tab being received within an opening in the intermediate portion.

An attachment clip for attaching an inflatable cushion to a vehicle, the attachment clip comprising: a first portion; a second portion coupled to the first portion in a facing spaced relationship, the second portion comprising a pair of flanges depending outwardly from the second portion; and a locking member coupled to the first portion, the locking member comprising a curved protrusion and an end flange depending away from the curved protrusion, wherein the first portion comprises a mounting surface.

An apparatus for attaching an inflatable cushion to a vehicle, comprising: a first means for engaging a portion of the inflatable cushion; a second means for engaging a portion of the vehicle, the second means being coupled to the first means, wherein the second means terminates in an engagement end, the engagement end being configured to slidably engage an opening in the vehicle.

An apparatus for attaching a vehicle trim portion to a vehicle, comprising: a first means for engaging a portion of the vehicle trim portion; a second means for engaging a portion of the vehicle, the second means being coupled to the first means, wherein the second means terminates in an engagement end, the engagement end being configured to slidably engage an opening in the vehicle.

### BRIEF DESCRIPTION OF THE DRAWINGS

FIG. 1 is a side elevational view of an inflatable cushion in a stored position;

FIG. 2 is a side elevational view of an inflatable cushion in a deployed state;

FIG. 3 is a side elevational view of another inflatable cushion in a deployed state;

FIG. 4 is a view along lines 4-4 of FIG. 1;

FIG. 5 is a perspective view of an attachment apparatus and a portion of a vehicle mounting surface constructed in accordance with an exemplary embodiment of the present invention;

FIG. 6 is a view along lines 6-6 of FIG. 5;

FIG. 7 is a view along lines 7-7 of FIG. 5;

FIG. 8 is another perspective view of an attachment apparatus and a portion of a mounting surface constructed in accordance with an exemplary embodiment of the present invention;

FIG. 9 is a perspective view of an attachment apparatus and mounting surface constructed in accordance with an alternative exemplary embodiment of the present invention;

FIG. 10 is a perspective view of an attachment apparatus and mounting surface constructed in accordance with another alternative exemplary embodiment of the present invention;

FIG. 11 is a side view of an attachment apparatus constructed in accordance with the alternative exemplary embodiment illustrated in FIG. 10;

FIGS. 12-14 are perspective views of an attachment apparatus and mounting surface constructed in accordance with still another alternative exemplary embodiment of the present invention;

FIGS. 15-16 are perspective views of an attachment apparatus and mounting surface constructed in accordance with still another alternative exemplary embodiment of the present invention;

FIGS. 17A-20 are perspective views of an attachment apparatus and mounting surface constructed in accordance with yet another alternative exemplary embodiment of the present invention;

FIG. 21 is a perspective view of an attachment apparatus and mounting surface constructed in accordance with yet another alternative exemplary embodiment of the present invention;

FIGS. 22A-22B illustrate still another alternative exemplary embodiment of the present invention;

FIGS. 23A-23D illustrate an attachment apparatus and mounting surface of still another alternative exemplary embodiment of the present invention;

FIGS. 24A-25 illustrate an attachment apparatus and mounting surface of still another alternative exemplary embodiment of the present invention;

FIG. 26 is a perspective view of yet another attachment apparatus and mounting surface of yet another alternative exemplary embodiment of the present invention; and

FIGS. 27A-27C illustrate still another alternative exemplary embodiment of the present invention.

### DETAILED DESCRIPTION OF EXEMPLARY EMBODIMENTS

This disclosure relates to methods and apparatus for securing portions of an inflatable cushion of a side-airbag device. More particularly, exemplary embodiments are directed to attachment apparatus that are configured to be attached to the inflatable cushion and are configured to slidably engage a mounting portion or mounting aperture of the vehicle or a mounting surface of the vehicle. In addition, each of the attachment apparatus are configured to allow an operator to blindly secure and lock the attachment apparatus to the vehicle mounting surface, which is appropriately configured to receive and engage features of the attachment apparatus. Exemplary embodiments also allow a side airbag or inflatable cushion to be installed without the need of a tool to be used within the vehicle. Moreover, the installer also does not need to enter the vehicle as exemplary embodiments only require an installer to reach their arm into the vehicle interior and then guide the attachment apparatus into a mounting opening. Other alternative exemplary embodiments are directed to an apparatus for securing a vehicle trim portion to a vehicle mounting surface.

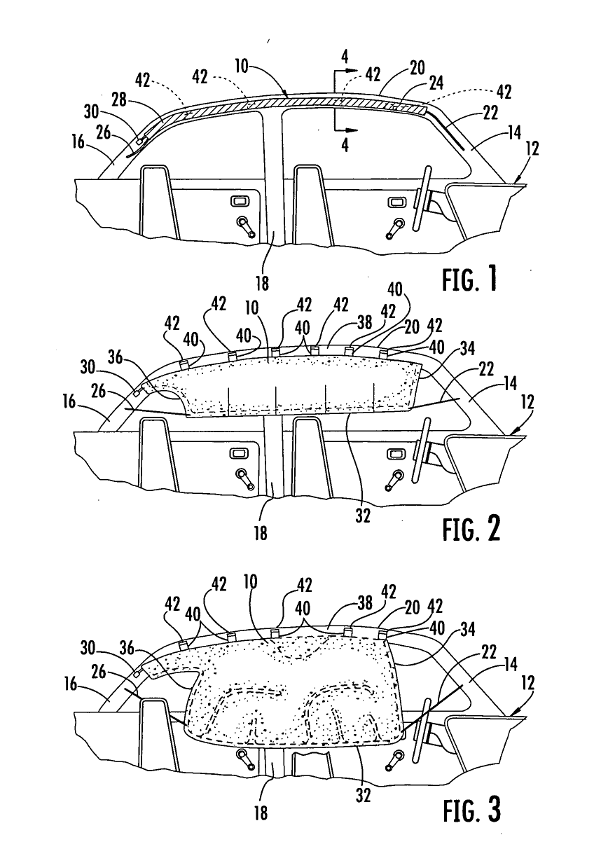

Referring now to FIG. 1, an inflatable cushion or airbag 10 is illustrated. Airbag 10 is manufactured and constructed in order to deploy in a variety of vehicle configurations. As discussed herein, exemplary embodiments of the present invention are related to apparatus and methods for securing side curtain airbags, such as inflatable cushion 10, to a vehicle interior. FIG. 1 provides a non-limiting example of an airbag or inflatable cushion 10 mounted to a vehicle 12 in a stored or non-deployed state. As illustrated, vehicle 12 comprises a front pillar 14, a rear pillar 16 and if the vehicle has more than one door per side, a center pillar or pillars 18 or as known to those skilled in the related arts A, B, C and D pillars. Inflatable cushion 10 is stored and mounted to or proximate to a vehicle roof rail 20 beneath a headliner. In some applications a first tether or connecting means 22 connects a front portion 24 of the inflatable cushion to the front pillar and a second tether or connecting means 26 connects a rear portion 28 of the inflatable cushion to the rear pillar.

It is, of course, understood that depending on the application requirements or configuration of the airbag device, inflatable cushion 10 may not require connecting means 22 and 26. Thus, connecting means 22 and 26 are provided as examples and the present invention is not intended to be limited by the same.

As illustrated, the rear portion of the air bag is in fluid communication with a gas generator or inflator 30 positioned to provide an inflation gas to inflate inflatable cushion 10. It is, of course, understood and as applications may vary, the positioning of the inflator may be located in other positions than those illustrated in the drawings. For example, the inflator may be located in a forward vehicle position. Thus, the presented location is provided as an example and the present invention is not intended to be limited by the same. In yet another alternative, the inflator may be remotely located and a conduit or other fluid providing means is used to supply the inflating gas from the inflator to the inflatable cushion.

FIGS. 2 and 3 illustrate inflatable cushion 10 of two different non-limiting designs in an inflated or deployed state. As illustrated in FIGS. 2 and 3, inflatable cushion 10 comprises a deploying edge 32, which comprises the bottom portion of the airbag that traverses across the window openings or window frames of the vehicle. Airbag 10 also comprises a forward edge 34, a rearward edge 36 and a fixed edge 38. Fixed edge 38 represents the portion of the airbag that remains in substantially the same position regardless of whether the airbag 10 is deployed or not.

Many different types of airbags or inflatable cushion arrangements (e.g., internal cavities, tethers or seams) are contemplated to be used with exemplary embodiments of the present invention. It is understood that the configuration of inflatable cushion 10 may vary and the illustrations in FIGS. 1 and 2 are provided as examples and the present invention is not intended to be limited to the specific configurations provided in the figures as they are considered ancillary to the present invention. Moreover, the present invention is contemplated for use with other vehicle configurations than those illustrated in FIGS. 1-2. For example, the vehicle may include three rows of seats. Such vehicles include but are not limited to sports utility vehicles, station wagons, vans or minivans. Conversely, the vehicle may comprise only a single row of seats such vehicles include but are not limited to sports coups.

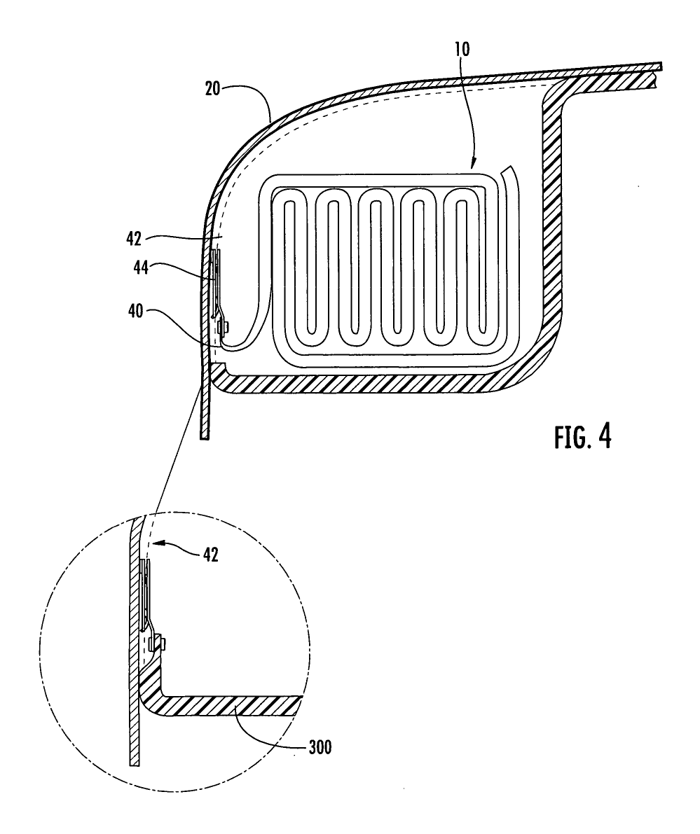

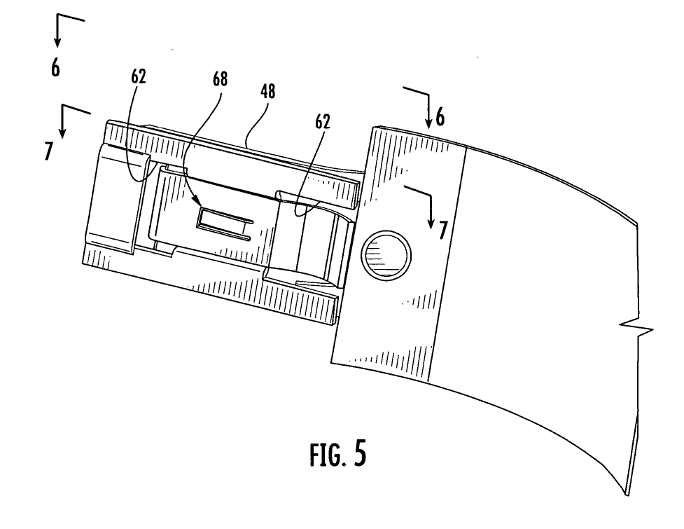

The inflatable cushion may be made of any suitable air bag material for holding gas. In an exemplary embodiment, the inflatable cushion comprises two sheets of woven nylon fabric lined with urethane or other substantially impervious material such as silicone. The two urethane coated nylon sheets are secured to one another along an outer periphery thereof to define the overall air bag shape. Prior to deployment, the inflatable cushion is stored in a compartment mounted to the roof rail 24 or proximate to the roof rail as shown in FIG. 1. In order to store the airbag into the compartment the un-inflated airbag is folded into a configuration which allows it to occupy a small discrete area within the vehicle interior (see FIG. 4). Moreover, such a configuration locates the attachment apparatus and securement end of the inflatable cushion behind the deployment portion of the cushion. Thus, the majority of the inflatable cushion is located in front of the securement or attachment apparatus and therefore exemplary embodiments of the present invention allow ease of securement of the cushion to the vehicle, as exemplary embodiments of the present invention do not require eye contact with the securement location and the attachment apparatus. Thus, the installer does not need to enter the vehicle as each of the attachment apparatus will be configured to self locate with regard to a mounting surface of the vehicle. Moreover, each of the attachment apparatus comprise a locking member or feature thus, the installer will be able to feel when the apparatus has been locked in place (e.g., locking into place).

In accordance with exemplary embodiments of the present invention, a machine folds the inflatable cushion in order to provide the configurations disclosed herein. It is also possible to fold the inflatable cushion by hand. It is also understood that the attachment apparatus are secured to the inflatable cushion before or after the folding process.

In accordance with an exemplary embodiment the fixed edge 38 comprises a plurality of mounting portions 40, which comprise a portion of the inflatable cushion and depend away from fixed edge 38. As illustrated, mounting portions 40 are each secured to an attachment apparatus 42, which in accordance with an exemplary embodiment are configured to slidably engage a feature (e.g., mounting surface, mounting aperture) 44 of the vehicle surface that is configured to engage the attachment apparatus 42. Alternatively, fixed edge 38 may be configured to have attachment apparatus 42 secured thereto negating the need for mounting portions 40. In accordance with an exemplary embodiment, apparatus 42 is fixedly secured to the airbag via any suitable method including rivets, bolts, studs, adhesives, etc. or equivalents thereof. In one exemplary embodiment, apparatus 42 is insert molded about a portion of the inflatable cushion.

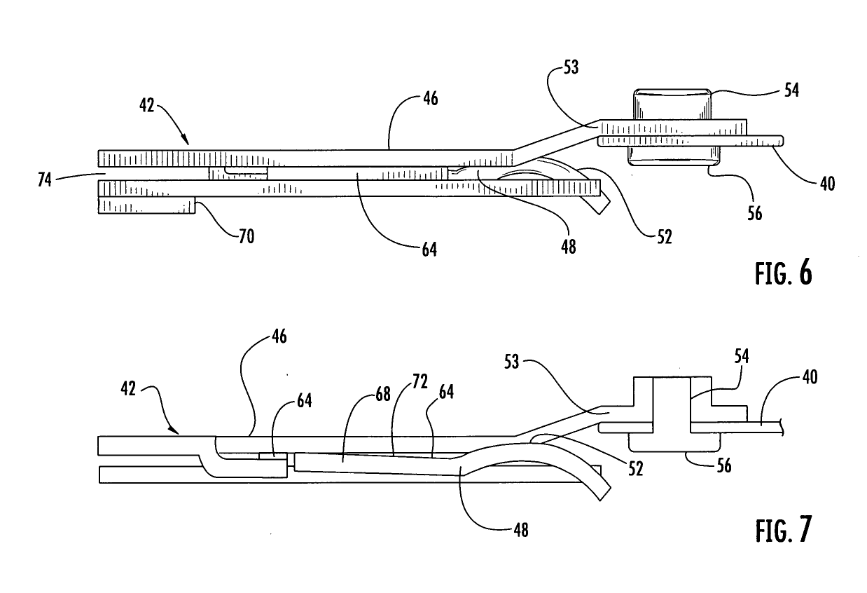

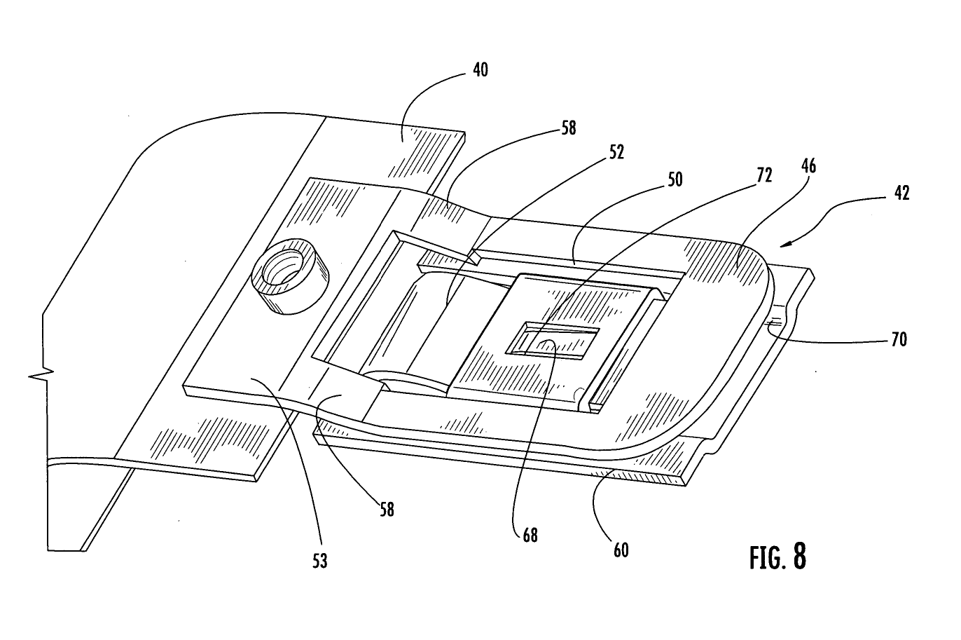

Referring now to FIGS. 4-8, an exemplary embodiment of attachment apparatus 42 is illustrated. In this embodiment, attachment apparatus 42 comprises a first portion 46 and a second portion 48 coupled to the first portion. As illustrated, first portion 46 defines an opening 50 and second portion 48 is configured to be positioned over opening 50 such that a portion or a protrusion 52 of second portion 48 is received within opening 50 when second portion 48 is in a first position with respect to first portion 46. First portion 46 is also configured to have an inflatable cushion attachment portion 53 wherein mounting portion 40 is secured thereto by an attachment means such as a rivet or other equivalent device comprising a shaft portion 54 and a head portion 56 for securing mounting portion 40 to attachment portion 53 of attachment apparatus 42.

Alternatively, an opening in mounting portion 40 may be configured to receive a portion of the attachment apparatus therein. As illustrated, attachment portion 53 is displaced away from first portion 46 so as to allow attachment apparatus 42 to be attached to a vehicle. This displacement in one embodiment is accomplished by an angled portion 58 of first portion 46.

For purposes of clarity only a portion of the vehicle mounting surface or vehicle roof rail to which the inflatable cushion is to be attached is illustrated. As shown, attachment apparatus 42 is configured to engage a complimentary securement feature 60 of the vehicle frame. In general and referring now to this particular embodiment, securement feature 60 comprises an opening 62 in the vehicle mounting surface. It being understood that multiple attachment apparatus and attachment locations are contemplated. For example, 5-6 attachment apparatus may be employed for a typical vehicle side airbag. It is, of course, understood that more or less attachment apparatus may be employed.

The opening in the vehicle frame of mounting surface comprises a locking portion or locking member 64 that is disposed over or bridges a portion of opening 62. Portion 64 bridges opening in a manner that locates the surface of portion 64 away from the surface bounding opening 62. In other words, opening 62 is partially covered by portion 64 wherein the surface of portion 64 is spaced away from opening 62 such that a channel or path is provided to allow a portion of attachment apparatus therethrough namely, second portion 48 of attachment apparatus 42. Locking portion or member 64 further comprises an engagement opening disposed therein.

In accordance with an exemplary embodiment second portion 48 includes an engagement tab 68 depending away from second portion 48. in accordance with an exemplary embodiment engagement tab 68 is configured to engage the engagement opening of the locking portion.

In addition, securement feature or vehicle mounting surface 60 further defines a channel portion 70 disposed laterally away from portion 64 and depends away from opening 62 in a direction opposite to portion 64. Accordingly, channel portion 70, opening 62 and portion 64 define a path in the vehicle mounting surface into which second portion 48 of the attachment apparatus is capable of being slid therethough.

Therefore, and in order to secure attachment apparatus 42 to securment feature or vehicle mounting surface 60 the distal end of second portion is first slid into channel portion 70, into opening 62, underneath locking portion 64 until protrusion 52 is received within the portion of opening 62 disposed on the side of locking portion 64 opposite from channel portion 70. In addition, protrusion 52 will also be received within opening 50 of first portion 46.

In addition and at this location, engagement tab 68 will engage an engagement tab opening 72 in locking portion 64. Thus, once engagement tab 68 is engaged in engagement tab opening 72 and protrusion 52 is engaged in opening 62 the attachment apparatus 42 and thus mounting portion 40 is secured to the vehicle. Furthermore, the locking feature of engagement tab 68 and protrusion 52 are configured (e.g., angular position) to prevent the attachment apparatus from being slid back out of securement feature or vehicle mounting surface 60, unless engagement tab 68 and protrusion 52 are manipulated away from first portion (e.g., biased away) by for example, a tool such as a blade of a screwdriver or other equivalent device. Thus, attachment apparatus 42 will snap into or provide ergonomic feel to the installer's hand indicating that the apparatus has been locked into place. Accordingly, the attachment apparatus is capable of being installed blindly into the vehicle mounting surface without requiring the installer to enter the vehicle.

In accordance with an exemplary embodiment it is understood that securement feature or vehicle mounting surface 60, locking portion or locking member 64, channel 70 and opening 62 (disposed on either side and below portion 64) are found in the mounting surface proximate to the vehicle roof rail. In order to provide such complimentary features for attachment apparatus of exemplary embodiments of the present invention channel 70, opening 62 and portion 64 may be stamped, machined or manufactured directly into the desired locations of the vehicle frame or alternatively mounting surface members with all of the required features may be separately secured to the vehicle frame. In the later embodiment, a flange portion comprising the necessary securement features (e.g., openings and mounting portions) may be provided wherein the flange portion is configured and mounted such that the mounting surface is spaced away from the vehicle frame such that the openings have the required depth to receive the engaging portions of the attachment apparatus. Should separate mounting flanges be required, the same could be separately secured to the vehicle frame or integrally molded thereto during the manufacturing of the frame. Accordingly, it is understood that the configuration of securement feature or mounting surface 60 may vary as well as the configurations of attachment apparatus as each vehicle configuration may pose different securement requirements.

In accordance with an exemplary embodiment attachment apparatus 42 is manufactured out of a material sufficient to hold the mounting portions 40 to the vehicle during deployment of the inflatable cushion. In addition, the material of attachment apparatus 42 is also of the type that will have a resilient characteristic or memory in order to allow second portion 48 to be biased away from a first position with respect to first portion 46 upon the application of a biasing force and then after the biasing force is no longer applied the resiliency of the material of attachment apparatus will cause second portion 48 and first portion 46 to return back to the first position (e.g., locked into place). It being understood that the biasing force is applied as the attachment apparatus is being slid into the vehicle mounting surface as attachment apparatus 42 is secured to the features of the vehicle (e.g., a distal end of second portion 48 being configured to engage the securement features of the vehicle). More particularly, a flexible connecting portion 74 couples first portion 46 to second portion 48. Non-limiting examples of suitable materials for attachment apparatus 42 include metals or alloys such steel, aluminum or plastics, and equivalents thereof and non-limiting examples of manufacturing processes include stamping, injection molding, insert molding, assembly, welding and equivalents thereof.

In summary, the attachment apparatus of FIGS. 5-8 comprises a first portion having an end secured to a mounting portion of the inflatable cushion. The first portion is also secured to a second portion of the attachment apparatus, wherein the second portion is configured to be temporarily biased away from the first portion and also comprises mounting features (e.g., tab 68 and protrusion 52) to engage securement features (channel 70, opening 62 and surface 64) of a vehicle mounting surface. In addition, the first portion is also configured (e.g., opening 50) to receive portions of the mounting features of the second portion. Finally, attachment apparatus is configured to facilitate sliding and locking engagement to the vehicle without direct eye contact to the mounting surface. Also and as applications may require, the first portion further comprises an inflatable cushion mounting surface angularly displaced from the rest of the first portion to provide a clearance between the inflatable cushion mounting surface and the vehicle mounting surface, if required. In other words, inflatable cushion mounting surface does not have to be angularly displaced away from the first portion (e.g., the inflatable cushion mounting surface may depend directly therefrom in a parallel direction). In this embodiment connecting portion 74 will provide any required clearance from the vehicle mounting surface.

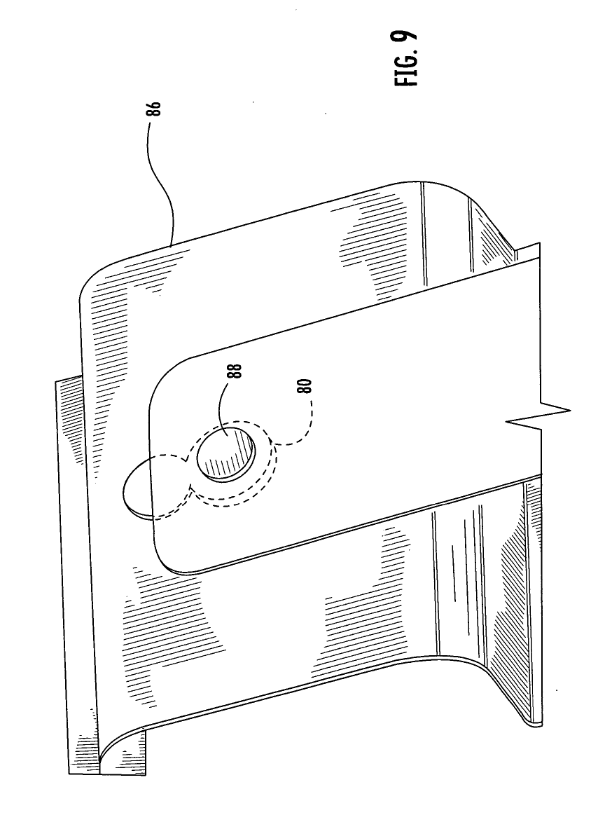

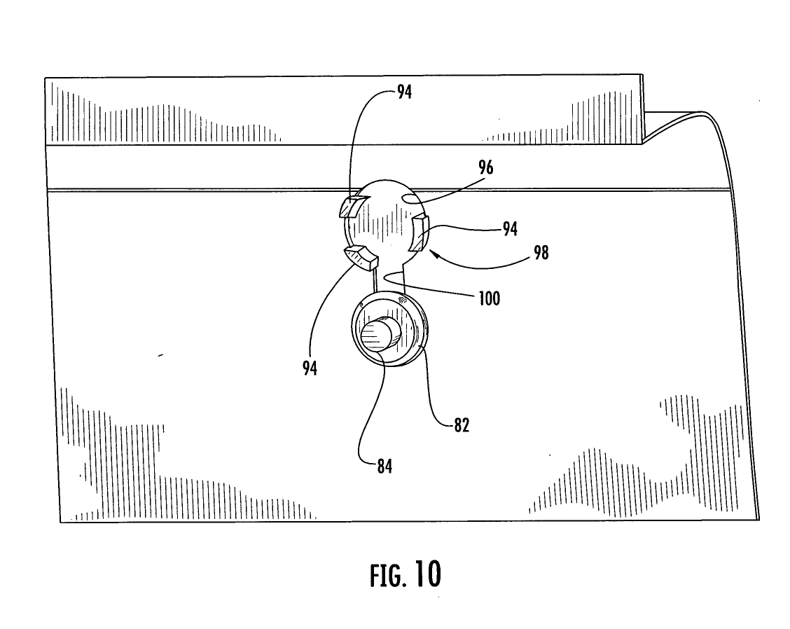

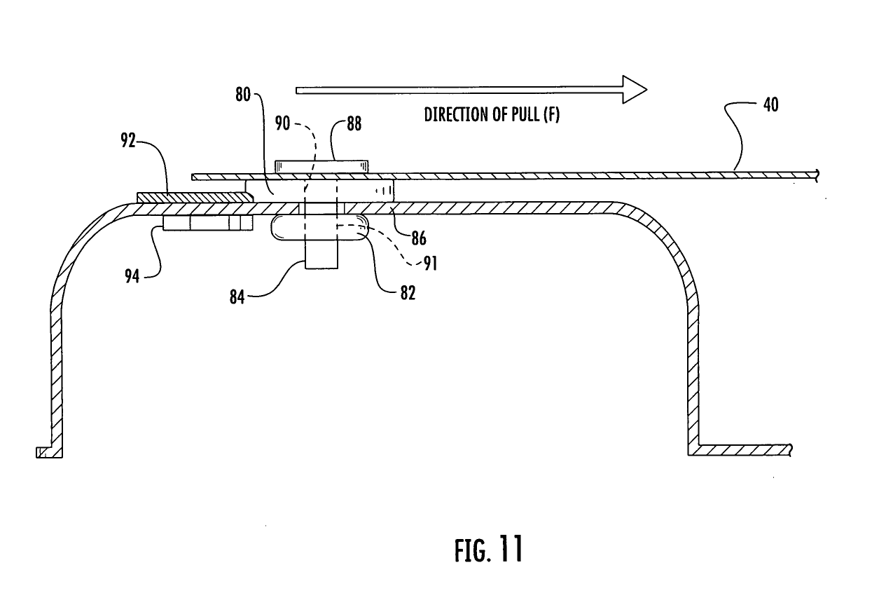

Referring now to FIGS. 9-12 an alternative exemplary embodiment of the present invention is illustrated. Here the attachment apparatus comprises a first engagement portion 80 coupled to a second engagement portion 82 by a connecting member 84, wherein the first engagement portion is disposed in a facing spaced relationship with respect to the second engagement portion so that a portion 86 of the vehicle mounting surface is receivable between the first engagement portion and the second engagement portion. In addition, and as will be discussed herein connecting member 84 will also comprise a means for securing the mounting portion of the inflatable cushion thereto.

Although portions 80 and 82 are illustrated as circular members it is understood that portions 80 and 82 may comprise any configuration (e.g., squares, triangles, ovals, ellipses, etc) as long as at least one of the portions is small enough to pass through a portion of an elongated opening in the vehicle mounting surface and thereafter the same portion must be larger than another portion of the elongated opening. Non-limiting examples are illustrated in the attached drawings. In this embodiment and variations thereof, the attachment apparatus is passed through a first larger portion of an engagement opening and slide therethorugh until a locking member locks the attachment apparatus into the desired location. Again, exemplary embodiments allow for the attachment apparatus to be secured to the vehicle mounting surface without the use of special tools and without the need to see the mounting location. As shown in FIGS. 9-12, first engagement portion 80 is larger than the second engagement portion. Thus, fist engagement portion 80 prevents the attachment apparatus from completely passing through the engagement opening.

In yet another alternative exemplary embodiment, and at least shown in FIGS. 9-12 portion 86 of the vehicle mounting surface may be “U” shaped or other equivalent structure to place opening or aperture 98 in a facing spaced relationship with respect to a vehicle surface so that aperture 98 is easily engaged and portions of the attachment apparatus may pass through a back side of the mounting surface (e.g., an area disposed between the vehicle frame and the mounting surface). Alternatively, and if enough space is provided in the vehicle frame, portion 86 may simply comprise an area of the vehicle frame and a plurality of mounting apertures are disposed therein. In addition, and in yet another alternative exemplary embodiment, portion 86 is separately attached to the vehicle after the apparatus and inflatable cushion is secured thereto. In yet another alternative exemplary embodiment portion 86 may comprise or is a portion of the vehicle interior trim located proximate to the roof rail mounting location.

In this embodiment, connecting member 84 also comprises a head portion 88 configured to secure mounting portion 40 to first engagement portion 80 by passing through an opening 90 within first engagement portion 80. Also, an opening 91, if necessary, is found in second engagement portion 82. In accordance with an exemplary embodiment, first engagement portion 80 is secured to mounting portion 40 by passing connecting member 84 through the openings in first engagement portion 80, second engagement portion 82 and if necessary an opening in mounting portion 40.

Thereafter, second engagement portion 82 is secured to connecting member 84. Non-limiting examples of securement methods include heat staking, ultra-sonic welding, welding, adhesives, press fitting, combinations and equivalents thereof. It is, of course, understood that depending on the materials used for portions 80 and 82 as well as connecting member 84 the securement methods will vary (e.g., heat staking may be more suitable for plastic materials etc). Regardless of the securement method employed, portions 80 and 82 are secured to connecting member 84 so that mounting portion 40 is secured to portion 80 (e.g., head portion 88) and portion 82 is spaced from portion 80 to allow sliding of the metal of mounting surface 86 therebetween (e.g. a facing spaced relationship). In order to accomplish this facing spaced relationship first engagement portion 80 may have a feature or shaft configured to pass through the opening in the vehicle however, this feature would be larger than opening 91 in second engagement portion 82 thus, connecting portion 84 would pass through opening 90 and opening 91 and then portions 80 and 82 are secured to each other via portion 84 and attachment portion 40 is secured to portion 80. Other alternative methods for securing portions 80 and 82 into facing spaced relationships include providing a removable temporary spacer between portions 80 and 82 during the attachment process.

In yet another alternative exemplary embodiment, first portion 80 and second portion 82 and any other of the aforementioned locking portions are formed by an injection molding process and inflatable cushion mounting portion 40 is secured thereto by any suitable attachment method. Non limiting attachment methods include rivets, bolts, studs, adhesives, etc. or equivalents thereof. In yet another alternative exemplary embodiment, first portion 80 and second portion 82 and any other of the aforementioned locking portions are insert molded directly to the inflatable cushion (e.g., an injection molding process wherein plastic is injected into a cavity and around an insert piece (e.g., the inflatable cushion mounting portion or a portion of the inflatable cushion or a metal portion or other portion of the attachment apparatus) placed into the same cavity just prior to molding. Thereafter, the result is a single piece with the insert encapsulated by the plastic wherein a molecular and mechanical bonding occurs between the insert and the molded parts. The insert can be made of metal or another plastic. Insert molding may be performed by using a standard injection molding press or a specific molding machine designed for insert molding.

Non-limiting materials suitable for use in insert molding processes are similar to those used in injection molding process for example; polyethylene, polystyrene, polypropylene, polyvinyl chloride, thermoplastic elastomers, and equivalents and combinations thereof.

In addition and in order to lock this attachment apparatus to the vehicle, first engagement portion 80 has a locking member 92 depending away from first engagement portion 80. As illustrated, locking member 92 depends laterally away from the portion 80 and has a plurality of locking tabs 94 depending away from locking member 92. In accordance with an exemplary embodiment tabs 94 depend away from locking member 92 in a direction that is perpendicular to the direction member 92 depends away from portion 80. Of course, other angles are contemplated to be within the scope of exemplary embodiments of the present invention. As illustrated, the locking tabs are configured, dimensioned and positioned to engage a first opening 96 of a mounting aperture 98 comprising first opening 96 and an engagement slot 100.

In accordance with an exemplary embodiment second engagement portion 82 is smaller than first engagement portion 80 such that second engagement portion 82 is capable of passing through first opening 96 but not engagement slot 100. In addition, connecting portion 84 or portions thereof or alternatively portions of engagement portion 82 are sized to slide within engagement slot 100 of mounting aperture 98.

Accordingly, and after the attachment apparatus of this embodiment is mounted to mounting portion 40 the attachment apparatus is secured to the vehicle by first passing second engagement portion through opening 96 and then sliding connecting portion 84 in engagement slot 100 until the locking tabs of locking portion 92 are then received within opening 96. Accordingly, the mounting portions of the inflatable cushion are attached to the vehicle by a plurality of simple devices each of which is mounted to the inflatable cushion. In accordance with an exemplary embodiment, each of these devices is mounted by a simple method of inserting, pulling and snapping of the locking tabs 94 into the opening 96. Contemplated materials for this apparatus include easily molded materials such as plastic. It is also understood that the locking members comprise a resilient material (e.g., plastic, metal etc.) capable of being deflected and returning to its un-deflected position once the locking tab engages the opening in the mounting surface.

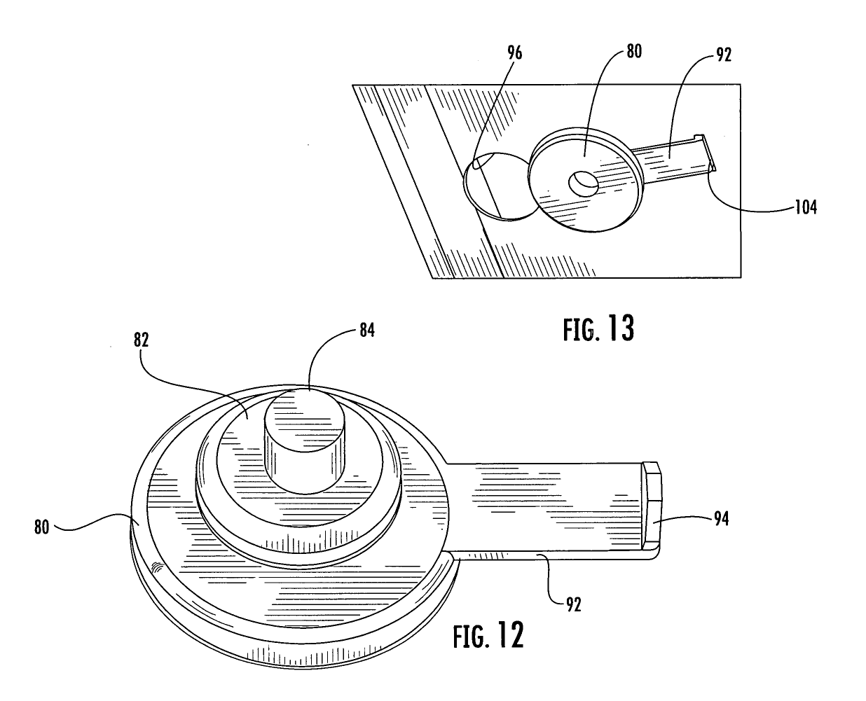

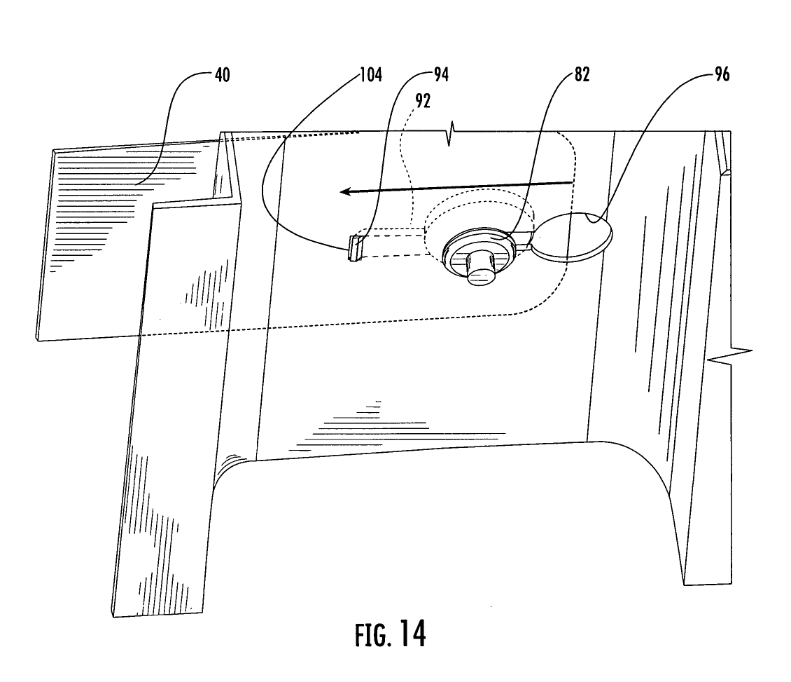

Referring now to FIGS. 12-14, another alternative exemplary embodiment of the present invention is illustrated. Here the locking member 92 depends away from portion 80 in a different direction and has a single locking tab 94 for engaging another opening 104 within the mounting surface of the vehicle. Opening 104 is also positioned in the surface having opening 98 disposed therein. Accordingly, and after the attachment apparatus of this embodiment is mounted to mounting portion 40 the attachment apparatus is secured to the vehicle by first passing second engagement portion through opening 96, sliding connecting portion 84 or portion of portion 80 in engagement slot 100 until the locking tab of locking portion 92 is engaged into opening 104. Again, the mounting portions of the inflatable cushion are attached by a simple device and method of inserting, pulling and snapping of the locking tab 94 into the opening 104. It is, of course, understood that locking portion 92 may comprise a plurality of locking tabs configured to engage a complimentary sized opening 104 in the vehicle.

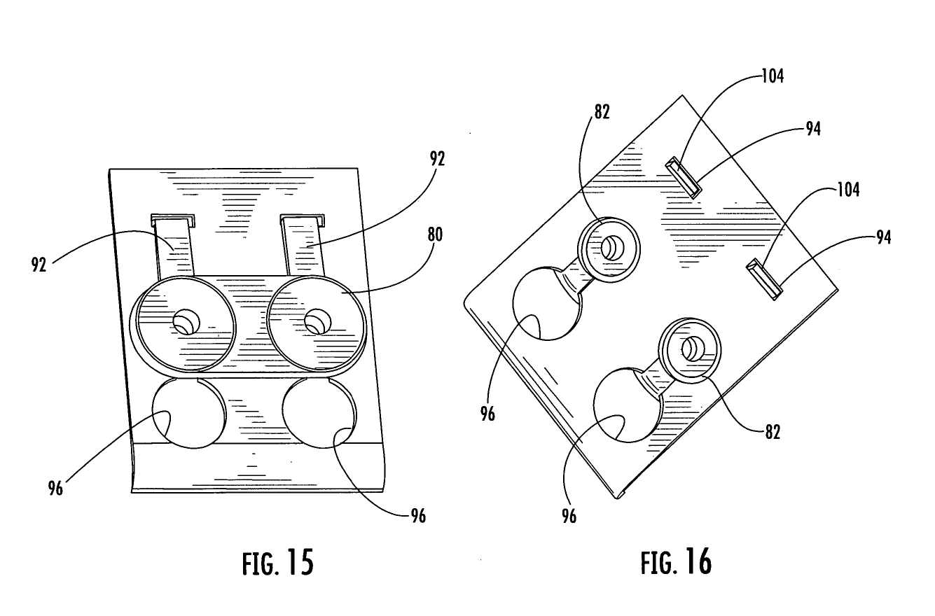

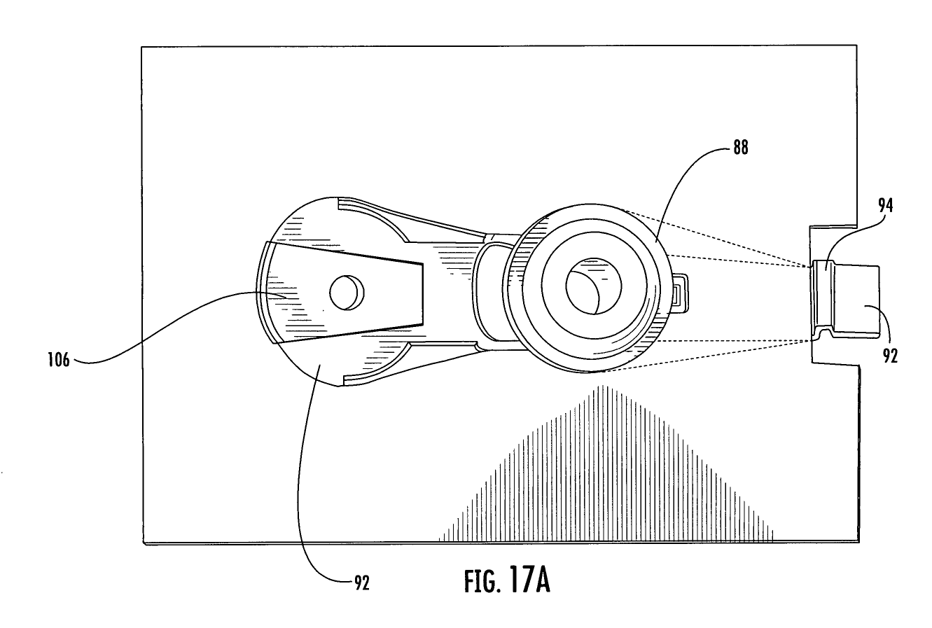

Referring now to FIGS. 15 and 16 yet another alternative exemplary embodiment of the present invention is illustrated. Here the first engagement portion 80 is an elongated member and a pair of second engagement portions 82 are coupled thereto by a pair of connecting members 84. In addition, first engagement portion 80 is also configured to have a pair of locking members depending away from the engagement portion, wherein the locking members have at least one locking tab 94 to engage openings 104 of the vehicle mounting surface. As illustrated, this embodiment is configured to engage a pair of openings 98 in the vehicle mounting surface. It is again understood that the locking members comprise a resilient material (e.g., plastic, metal etc.) capable of being deflected and returning to its un-deflected position once the locking tab engages the opening in the mounting surface.

In this embodiment, the larger engagement portion 80, pair of engagement portions 82 and locking portions 92 may provide a more robust point of securement as a large surface area is provided.

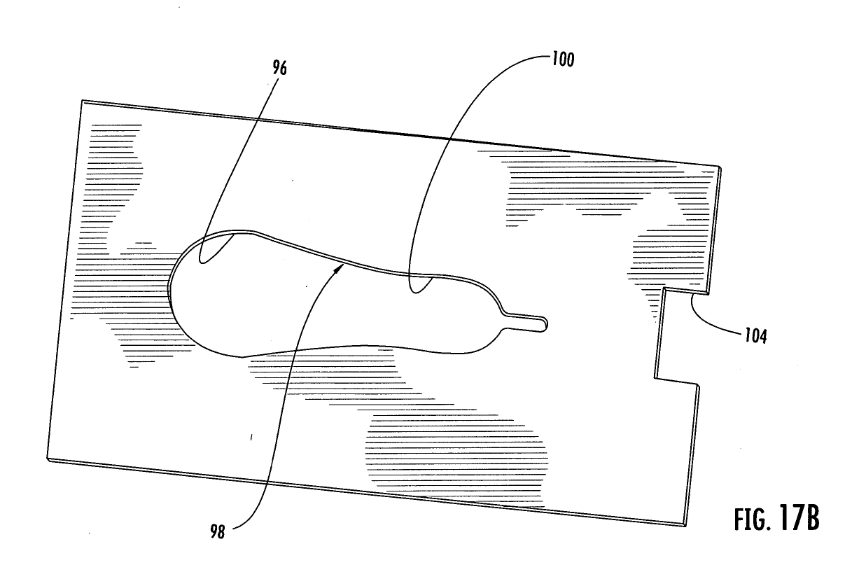

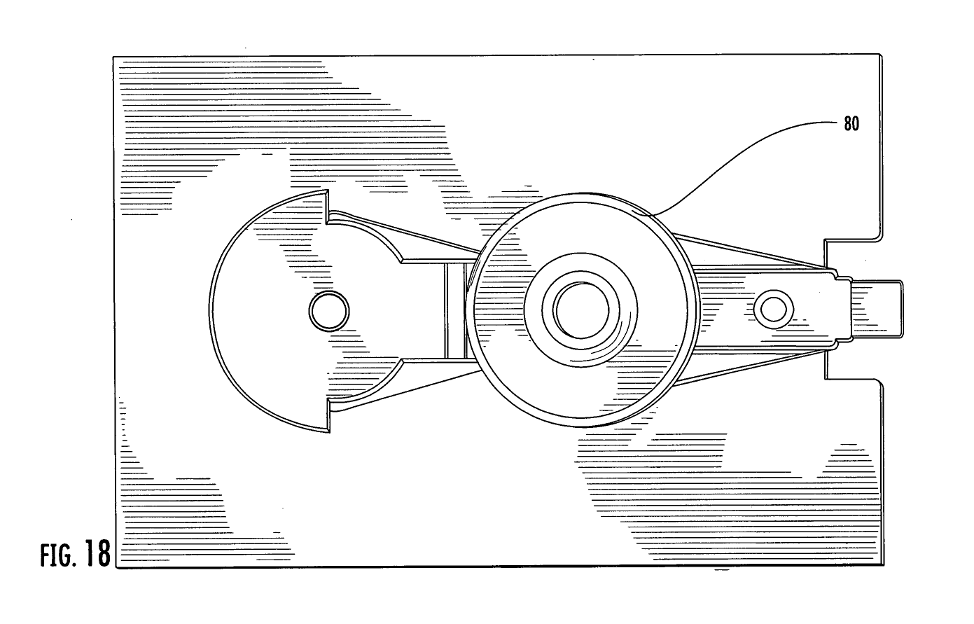

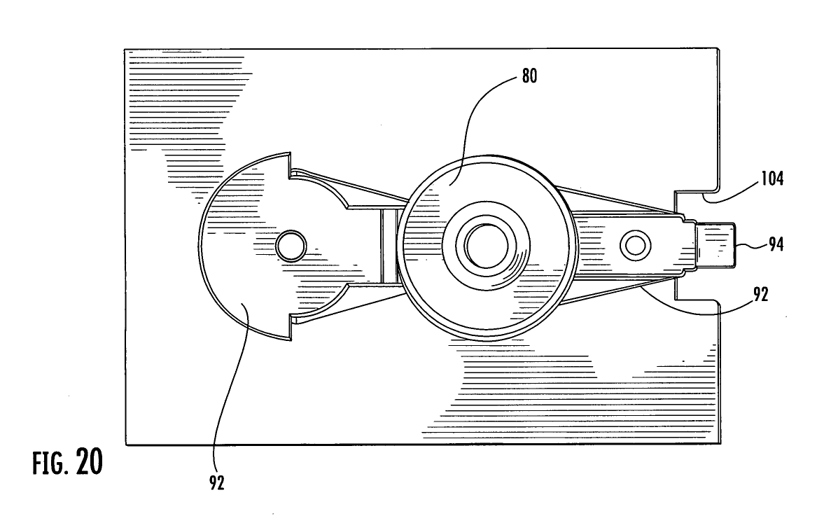

Referring now to FIGS. 17A-26, other alternative exemplary embodiments of the present invention are illustrated. For example, FIGS. 17A-20 illustrate an alternative exemplary embodiment wherein the attachment apparatus comprises a pair locking members 92 depending away from first engagement portion 80. In this embodiment, one of the locking members comprises engagement features 106 configured to engage separate portions (96 and 100) of aperture 98. As illustrated, features 106 comprise an angled or chamfered surface configured to slidably engage the opening of the mounting surface. Also, the other one of the locking members is configured to have a feature 94 for engaging opening 104. In this embodiment, each of the locking members depend away from portion 80 in opposite directions.

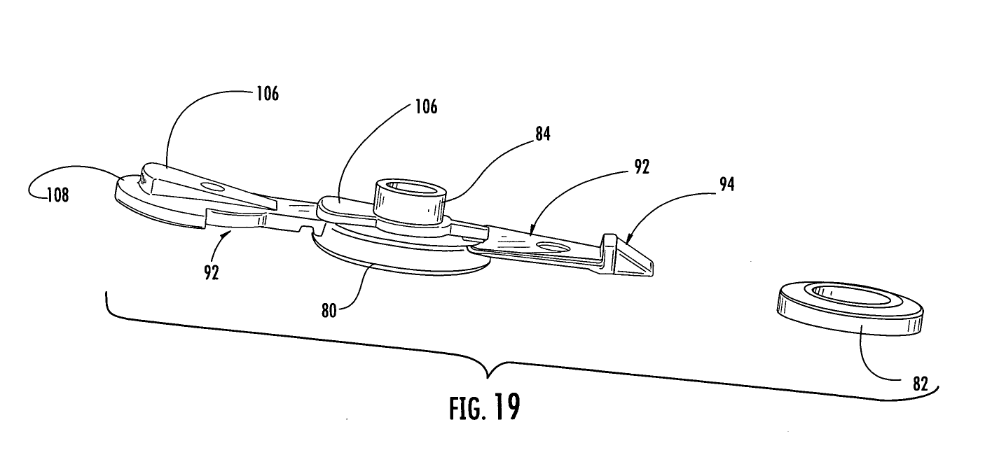

As illustrated in FIG. 19, the engagement features positioned about connecting member 84 can also provide the means for spacing second engagement portion 82 in a spaced relationship with respect to first engagement portion 80. Furthermore, other engagement features 106 are configured to engage the area of opening 100 (FIG. 17B) as the attachment apparatus is slid within opening 98. For example, one feature 106 is configured to engage portion 100 of the opening while another feature is configured to engage portion 96 of the opening. In addition, a shoulder portion 108 is defined on one of the locking members. In this embodiment, the shoulder portion 108 is configured to engage a periphery of opening 96. Furthermore, the other locking member is configured to have a tab 94 for engaging opening 104.

Also, and in yet another alternative the second engagement portion 82 may be molded directly onto connecting portion 84.

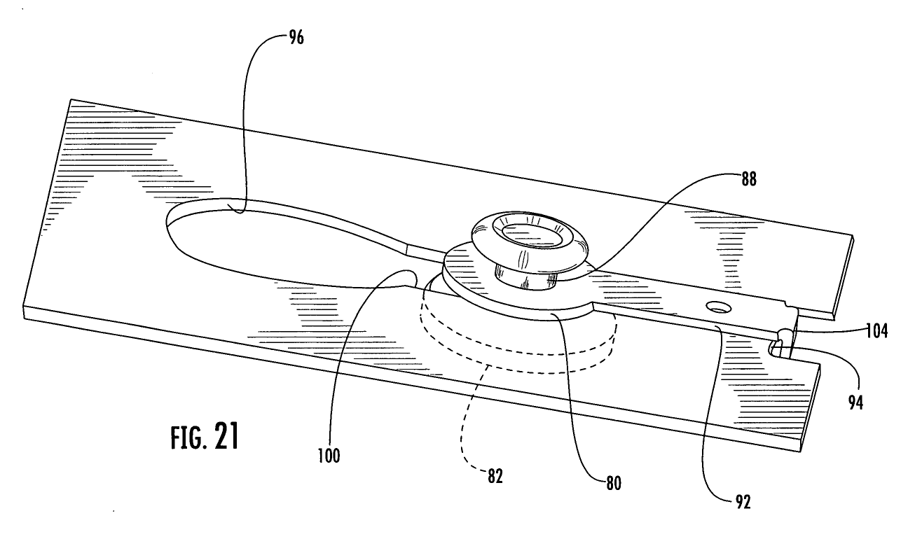

Referring now to FIG. 21, yet another alternative exemplary embodiment is illustrated. Here first engagement portion 80 is smaller than second engagement portion 82 and the connecting member is a rivet.

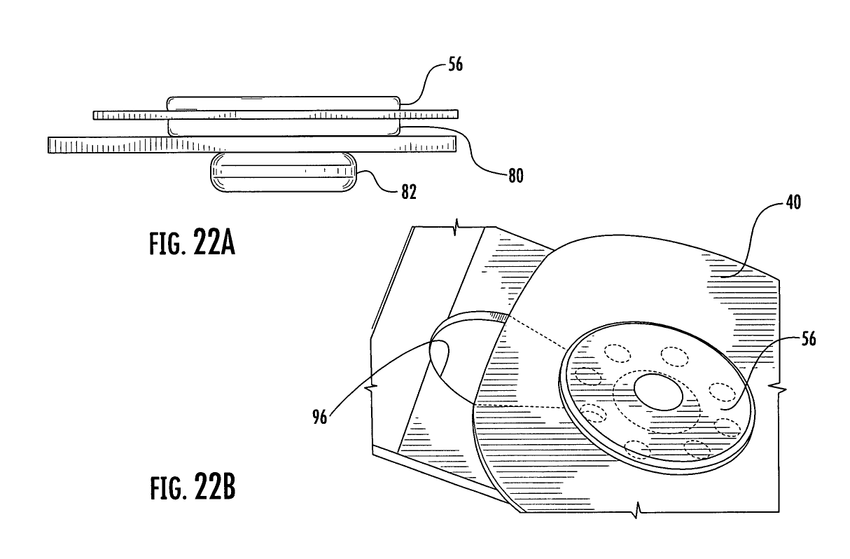

Referring now to FIGS. 22A-22B, yet another alternative exemplary embodiment is illustrated. Here the attachment apparatus is insert molded directly to mounting portion 40 of the inflatable cushion. As illustrated, a head portion 56 that is nearly the same diameter or shape as first engagement portion 80 is secured to one side of mounting portion 40 and first engagement portion 80 is secured to the other side of mounting portion 40. Again, the first engagement portion is again larger than the second engagement portion 82. In this embodiment, portion 40 would be positioned in an insert molding cavity (not shown) and openings are provided in portion 40 to allow for the liquid plastic of the insert molding process to pass therethrough when portions 56 and 80 are insert molded about portion 40. It being understood that the entire attachment apparatus including locking portion 92 of any of the aforementioned attachment apparatus may be insert molded directly to mounting portion 40.

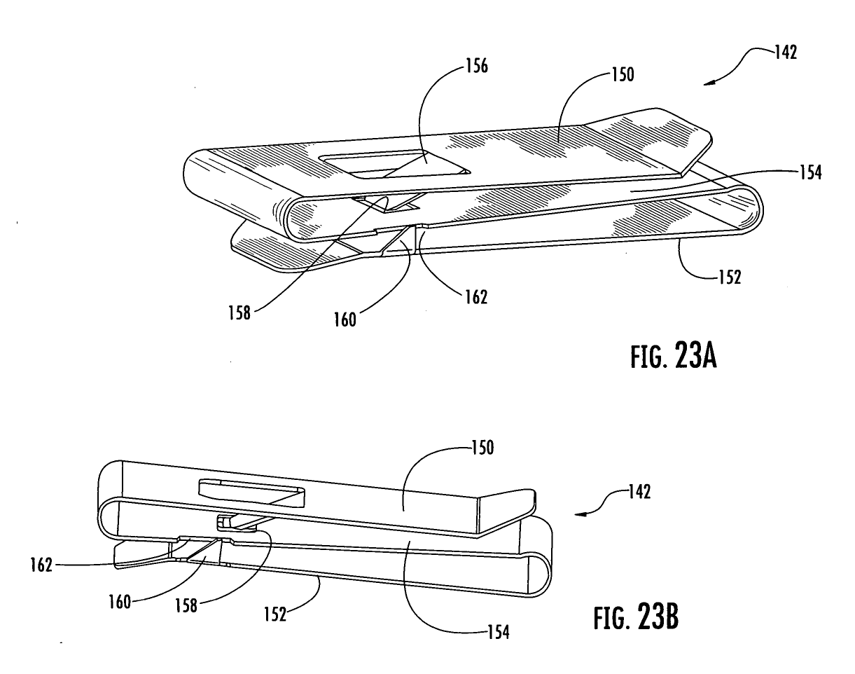

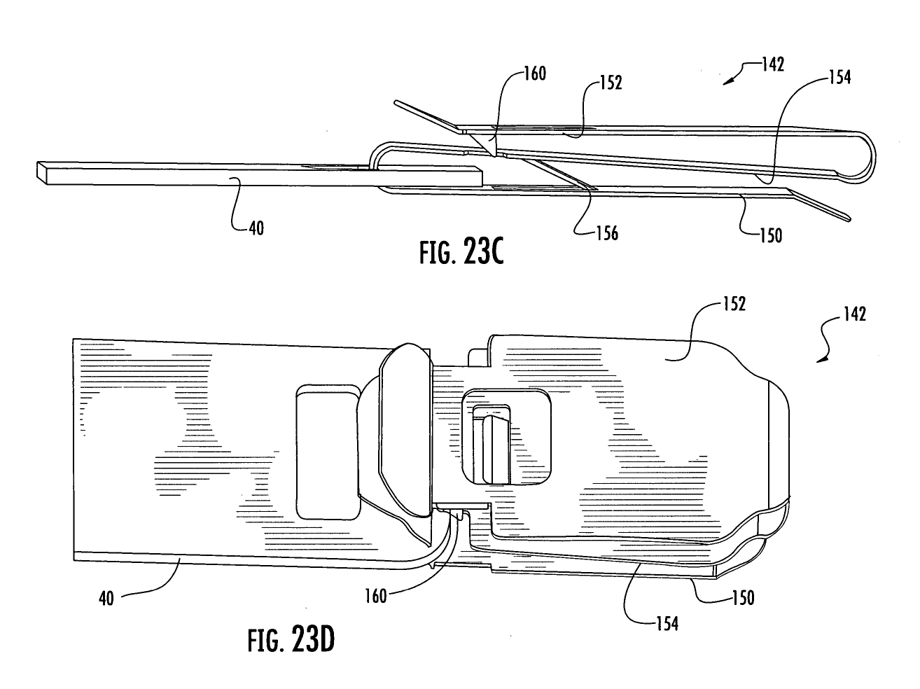

Referring now to FIGS. 23A-23C, yet another alternative exemplary embodiment is illustrated. In this embodiment, the attachment apparatus resembles an attachment clip 142 for attaching a mounting portion of an inflatable cushion to a vehicle. In this embodiment, the attachment clip comprises a first outer portion 150, a second outer portion 152; and an intermediate portion 154 coupled to and disposed between the first outer portion and the second outer portion, wherein the first outer portion is in a facing spaced relationship with respect to the intermediate portion and the second outer portion is also in a facing spaced relationship with respect to the intermediate portion. As illustrated, attachment clip 142 is configured to have a serpentine or substantially “Z” or “S” shape or any equivalent thereof.

The attachment apparatus further comprises an engagement tab 156 depending away from the first outer portion. The engagement tab being configured to have a portion received in an opening 158 in the intermediate portion when the first outer portion is in a first position with respect to the intermediate portion. Engagement tab 156 prevents the attachment portion of the inflatable cushion from sliding back out once it is looped within the attachment apparatus (See FIG. 23C). In addition, the second outer portion has a protrusion or pair of tabs 160 configured to have a portion received within an opening or notches 162 disposed in the intermediate portion when the second outer portion is in an initial position with respect to the intermediate portion. Tabs 160 will provide a means for locking the attachment apparatus to a vehicle mounting surface once second outer portion is slid into and engages an opening in the vehicle mounting surface.

In one exemplary embodiment the second outer member has a pair of protrusions 160 depending away from a periphery of the second outer portion and each of the pair of protrusions are configured to have a portion received in an opening or notch disposed in a peripheral portion of the intermediate portion. In this embodiment, the mounting portion of the inflatable cushion is slid between one of the outer members and the intermediate member and then the apparatus is secured to the vehicle wherein the other outer member is slid within an opening in the vehicle wherein the vehicle and the mounting portion of the inflatable cushion are each configured to have openings to receive the outer members and the engagement tab or protrusion depending therefrom (e.g. either portion may be used for the vehicle mounting portion or the inflatable cushion mounting portion and vice versa). For example, tabs 160 will lockingly engage complimentary openings in the vehicle mounting surface once the attachment apparatus through another opening in the vehicle mounting surface.

In addition, and as illustrated, each end of the inner and outer portions is chamfered to have an engagement surface configured to facilitate the sliding of the apparatus with respect to the vehicle and the inflatable cushion.

Moreover, and in accordance with an exemplary embodiment the material of attachment apparatus 142 is also of the type that will have a resilient characteristic in order to allow outer portions to be biased away from the intermediate portion upon the application of a biasing force and then after the biasing force is no longer applied the resiliency of the material of attachment apparatus will cause the outer portions to return back to the original position. It being understood that the biasing force is applied as the attachment apparatus is being slid into the vehicle mounting surface as attachment apparatus 142 is secured to the vehicle. Non-limiting examples of suitable materials include metals or alloys such steel, aluminum or plastics, and equivalents thereof. In addition, the materials will also be of a sufficient strength to withstand the forces exerted upon it during the deployment of the inflatable cushion.

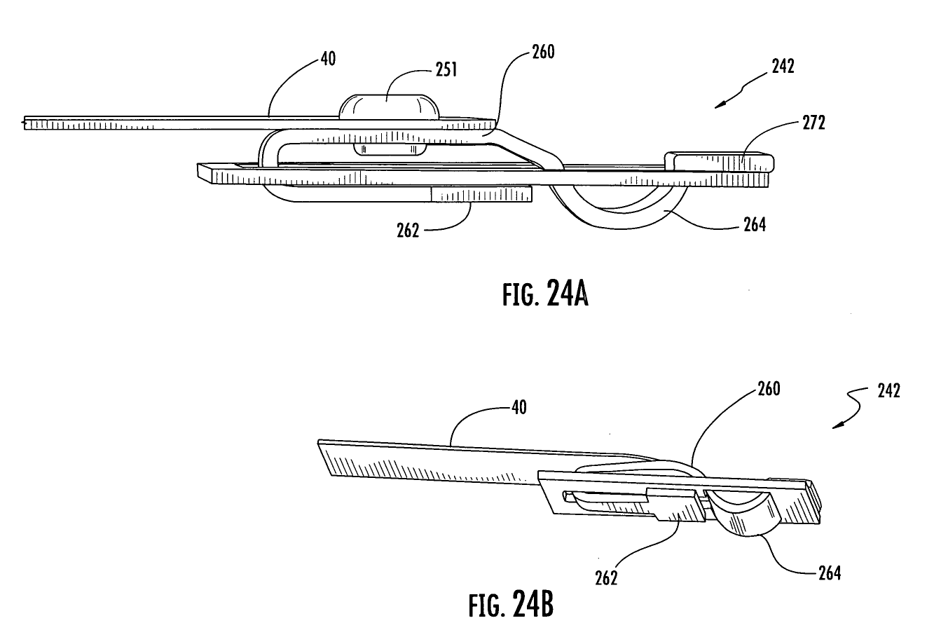

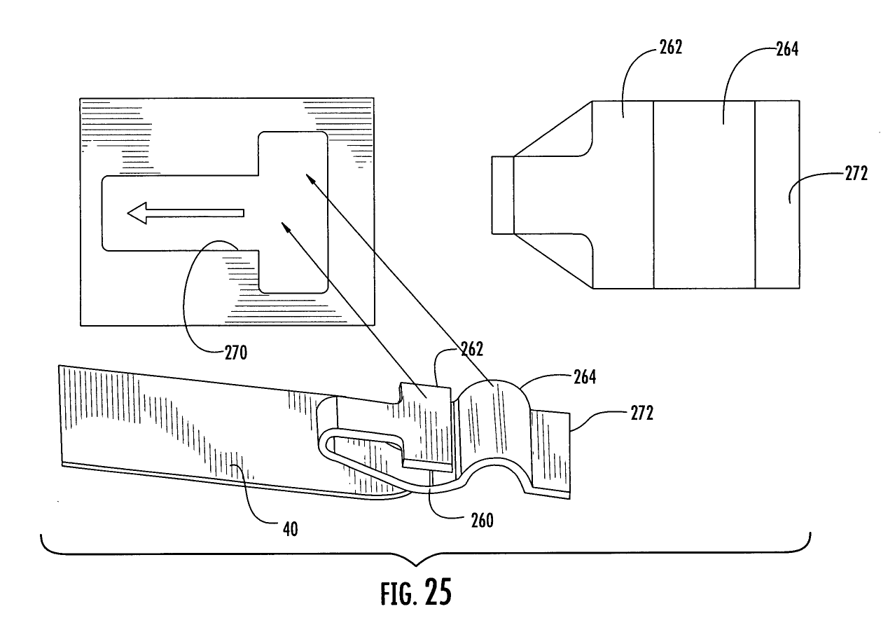

Referring now to FIGS. 24A-25, yet another alternative exemplary embodiment is illustrated. In this embodiment, the attachment apparatus is a unitary item 242 attached to the mounting portion 40 of the inflatable cushion by means of a rivet 251. In this embodiment, the attachment device 242 comprises a mounting surface 260, a first engagement portion 262 depending away from the mounting surface and a second engagement portion 264 depending away from the mounting surface. As illustrated in the Figures apparatus 242 is configured for use with a “T” shaped opening 270 in vehicle mounting surface. Accordingly portion 262 also comprises a “T” shaped flange portion slightly smaller than “T” shaped opening 270 in order to allow portion 262 to slid therethrough. Operation of this device is as follows: insertion of the “T” shaped first engagement portion 262 in opening 270, sliding the same therein until the second engagement portion comprising a rounded surface 264 is received within the opening. In this embodiment rounded surface 264 is configured to be received within the top or cross of the “T” shaped opening. Once received therein a flat portion 272 makes contact with a periphery of the opening and the apparatus and the mounting portion of the inflatable cushion is secured to the vehicle. In this embodiment, securement is facilitated by portion 262 engaging the periphery of the opening on one side and portion 272 engaging a periphery of the opening on the other side, wherein rounded portion 264 is received within the opening and spring bias is provided by the material used and in particular the portion of the apparatus disposed between portions 260 and 262 (e.g., a connecting portion).

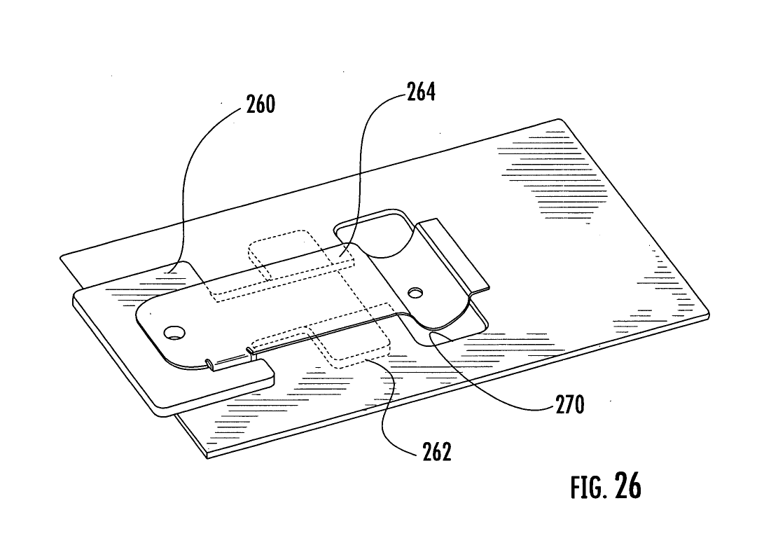

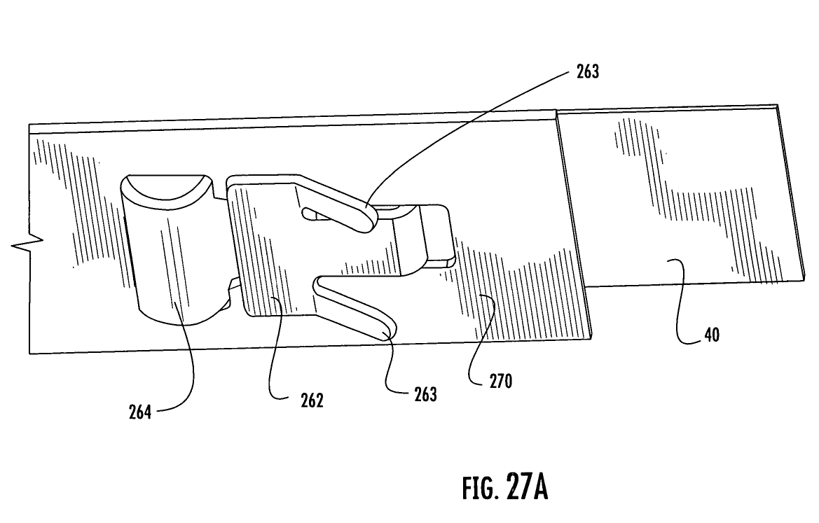

Referring now to FIG. 26, yet another alternative exemplary embodiment is illustrated. In this embodiment, the first engagement portion 262 and the second engagement portion 264 depend directly away from the point of securement to the attachment portion of the inflatable cushion.

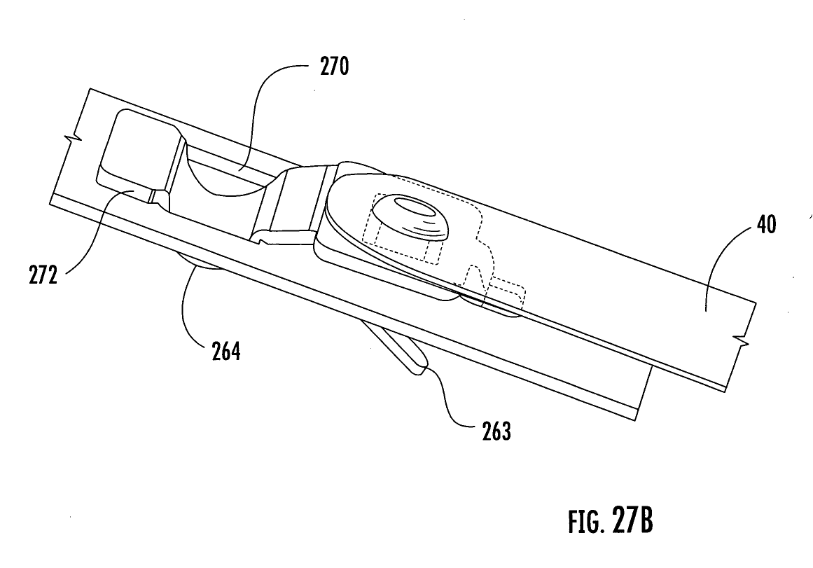

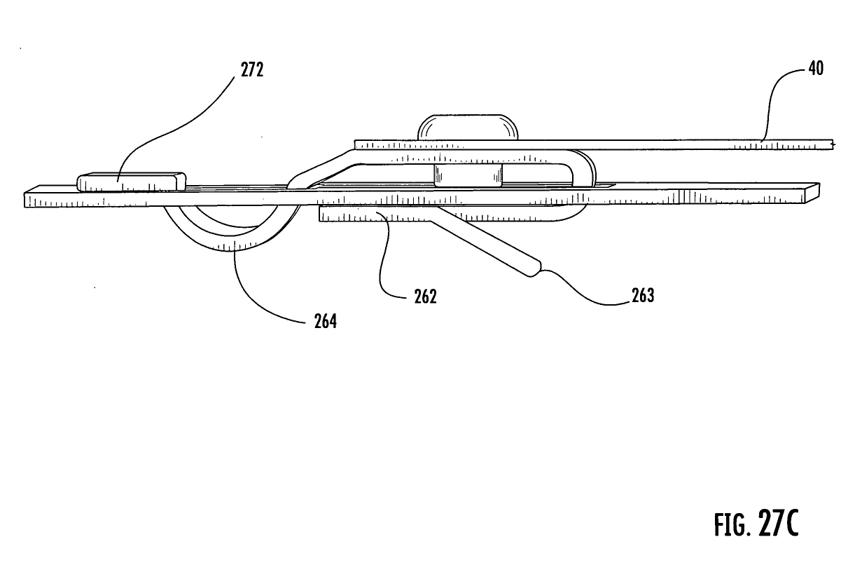

Referring now to FIGS. 27A-27C, yet another alternative exemplary embodiment is illustrated. In this embodiment, the first engagement portion 262 further comprises a pair of engagement tabs 263 angularly positioned with respect to first engagement portion 262 thereby providing a means for leading first engagement portion 262 into opening 270. As illustrated and as the apparatus is inserted in the “T” shaped opening 270 in the vehicle mounting surface, engagement tabs 263 will guide first portion 262 into opening 270 as the same is slid with respect to the mounting surface. Thereafter portion 264 is received within opening 270.

In yet another alternative embodiment, it is contemplated that any of the aforementioned attachment apparatus may be used and/or be configured to be used with interior trim pieces or interior trim portions thereby providing a means for attaching the same to interior vehicle surfaces. In other words, the attachment apparatus may be configured for securing vehicle trim pieces instead of a means for mounting the inflatable cushion to the vehicle or alternatively the attachment apparatus is used for securing both the inflatable cushion and the interior trim portion to the vehicle mounting surface. In this embodiment and referring now to FIGS. 4-27C mounting portion 40 is replaced by a mounting portion of an interior vehicle trim portion. In one non-limiting exemplary embodiment, and as illustrated in the enlarged portion of FIG. 4, a vehicle trim portion 300 is shown being attached to a vehicle mounting surface by an attachment apparatus 42. In this embodiment any one of the aforementioned attachment apparatus may be used for securing the vehicle trim portion to the vehicle mounting surface. It also being understood that any vehicle trim portion may be secured to a vehicle mounting surface using any of the aforementioned attachment apparatus of exemplary embodiments of the present invention.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. An apparatus for attaching an inflatable cushion to a vehicle, comprising:
a first portion;
a second portion coupled to the first portion, the second portion being in a facing spaced relationship with respect to the first portion; and
an engagement tab depending away from the second portion towards the first portion; and
wherein the second portion terminates in an engagement end, the engagement end having a protrusion located in an opening of the first portion.

2. The apparatus as in claim 1, wherein the first portion is coupled to the second portion by a connecting portion, which allows the engagement end to be biased away from the opening upon application of a force to the engagement end and the connecting portion being configured to provide a return biasing force to return the engagement end back towards the opening when the force is no longer applied to the engagement end, wherein the protrusion is defined by a curved portion of the second portion.

3. The apparatus as in claim 1, wherein the engagement tab is stamped from the second portion and is angularly positioned with respect to the second portion and the first portion further comprises a mounting portion configured for attachment to the inflatable cushion.

4. The apparatus as in claim 1, wherein the first portion further comprises an inflatable cushion attachment portion, the inflatable cushion attachment portion is displaced away from the first portion such that a mounting portion of the inflatable cushion is spaced away from a mounting surface of the vehicle, wherein the inflatable cushion attachment portion further comprises an angled portion depending away from the first portion.

5. An attaching assembly for attaching an inflatable cushion to a vehicle, comprising:
an attachment clip for attaching the inflatable cushion to a mounting surface of the vehicle, the attachment clip comprising
a first portion secured to a mounting portion of the inflatable cushion;
a second portion, the second portion being in a facing spaced relationship with respect to the first portion;
an engagement tab depending away from the second portion, wherein the second portion terminates in an engagement end, the engagement end having a protrusion located in an opening of the first portion; and
wherein the protrusion is configured to engage an opening in the mounting surface and the engagement tab is configured to engage another opening in the mounting surface.

6. The attachment assembly as in claim 5, wherein the first portion is coupled to the second portion by a connecting portion, which allows the engagement end to be biased away from the opening upon application of a force to the engagement end and the connecting portion being configured to provide a return biasing force to return the engagement end back towards the opening when the force is no longer applied to the engagement end, wherein the protrusion is defined by a curved portion of the second portion and the second portion is configured to be slidably received within a channel of the mounting surface.

7. The attachment assembly as in claim 5, wherein the mounting surface further comprises a channel portion disposed proximate to the opening in the mounting surface and the another opening is located in a locking member that bridges the opening in the mounting surface in a facing spaced relationship to define a covered portion of the opening in the mounting surface.

8. An apparatus for attaching an inflatable cushion to a vehicle, comprising:
a first engagement portion coupled to a second engagement portion by a connecting member, wherein the first engagement portion is disposed in a facing spaced relationship with respect to the second engagement portion, wherein the first engagement portion is smaller than the second engagement portion; and
a locking member depending laterally away from the second engagement portion.

9. The apparatus as in claim 8, wherein the locking member is configured to have a plurality of locking tabs depending away from the locking member, wherein the locking member and the locking tabs are configured and positioned to engage a portion of an elongated opening after the first engagement portion has passed therethrough.

10. The apparatus as in claim 9, wherein the second engagement portion further comprises another locking member depending laterally away from the second engagement portion in a direction opposite to the locking member, the another locking member further comprising a tab portion for engaging another opening after the first engagement portion has passed through the elongated opening.

11. The apparatus as in claim 8, wherein the locking member is configured to have a locking tab depending away from the locking member, wherein the locking tab is configured and positioned to engage another opening after the first engagement portion has passed through the elongated opening.

12. The apparatus as in claim 8, wherein the locking member further comprises a first locking member depending laterally away from the second engagement portion in a first direction and a second locking member depending laterally away from second engagement portion in a second direction, the second direction being opposite the first direction, wherein the first locking member is configured to have a first locking feature depending away from the first locking member, wherein the first locking feature is configured and positioned to engage a portion of an elongated opening after the first engagement portion has passed therethrough and the second locking member is configured to have a second locking feature depending away from the second locking member, wherein the second locking feature is configured and positioned to engage an other opening after the first engagement portion has passed through the opening.

13. The apparatus as in claim 12, wherein the first locking feature is a chamfered surface and the second locking feature is a tab portion.

14. The apparatus as in claim 8, wherein the first engagement portion comprises a pair of first engagement portions, the pair of first engagement portions being in a facing spaced relationship with respect to the second engagement portion and the locking member further comprises a pair of locking members depending laterally away from the second engagement portion, wherein each of the pair of locking members is configured to have a locking tab.

15. The apparatus as in claim 8, wherein the second engagement portion is insert molded about a mounting portion of an inflatable cushion.

16. An attachment clip for attaching an inflatable cushion to a vehicle, the attachment clip comprising:
a first outer portion;
a second outer portion;
an intermediate portion coupled to and disposed between the first outer portion and the second outer portion, wherein the first outer portion is in a facing spaced relationship with respect to the intermediate portion in a first position of the first outer portion and the second outer portion is also in a facing spaced relationship with respect to the intermediate portion in an initial position of the second outer portion; and
an engagement tab depending away from the first outer portion, a portion of the engagement tab being received within an opening in the intermediate portion, when the first outer portion is in the first position.

17. The attachment clip as in claim 16, wherein the second outer portion has a pair of tabs depending away from an outer periphery of the second outer portion.

18. The attachment clip as in claim 17, wherein the pair of tabs are received in a pair of complimentary notches disposed on an outer periphery of the intermediate portion when the second outer portion is in the initial position.

19. The attachment clip as in claim 17, wherein the first outer portion is movably secured to the intermediate portion such that the first outer portion can be biased away from the intermediate portion and the first position upon application of a force to the first outer portion and the attachment clip is configured to provide a return biasing force to return the first outer portion back towards the intermediate portion and the first position when the force is no longer applied to the first outer portion and the second outer portion is movably secured to the intermediate portion such that the second outer portion can be biased away from the intermediate portion and the initial position upon application of a force to the second outer portion and the attachment clip is configured to provide a return biasing force to return the second outer portion back towards the intermediate portion and the initial position when the force is no longer applied to the second outer portion.

20. The attachment clip as in claim 19, wherein the first outer portion is secured to the intermediate portion at a first end of the intermediate portion and the second outer portion is secured to the intermediate portion at a second end of the intermediate portion, the first end being opposite to the second end and the second outer portion has a pair of tabs depending away from an outer periphery of the second outer portion, wherein a portion of the pair of tabs are received in a pair of complimentary notches disposed on an outer periphery of the intermediate portion when the second outer portion is in the initial position.

21. An attachment clip for attaching an inflatable cushion to a vehicle, the attachment clip comprising:
a first portion;
a second portion coupled to the first portion in a facing spaced relationship, the second portion comprising a pair of flanges depending outwardly from the second portion; and
a locking member coupled to the first portion, the locking member comprising a curved protrusion and an end flange depending away from the curved protrusion, wherein the first portion comprises a mounting surface.

22. The attachment clip as in claim 21, wherein each of the pair of flanges further comprises a guide member depending angularly away from the each one of the pair of flanges, wherein the guide member is configured to guide the pair of flanges though a mounting opening.

23. The attachment clip as in claim 21, wherein the pair of flanges and the second portion provide a “T” shaped member for engaging a complimentary “T” shaped opening.

24. The attachment clip as in claim 21, wherein the locking member comprises a resilient member secured to the first portion.

25. An apparatus for attaching an inflatable cushion or a vehicle trim portion to a vehicle, comprising:
a first means for engaging a portion of the inflatable cushion;
a second means for engaging a portion of the vehicle, the second means being coupled to the first means, wherein the second means terminates in an engagement end, the engagement end being configured to slidably engage an opening in the vehicle.

26. The apparatus as in claim 25, wherein the second means is movably coupled to the first means to define a first position, wherein the first means can be biased away from the second means upon application of a biasing force to the first means and the apparatus is configured to provide a return biasing force to return the first means towards the second means and the first position when the biasing force is no longer applied to the first means.

27. The apparatus as in claim 25, wherein the second means further comprises at least one locking member for engaging another opening in the vehicle.

28. The apparatus as in claim 25, wherein the second means further comprises a first locking member for engaging a portion of the opening in the vehicle after the first means has passed therethrough and the second means further comprising a second locking member for engaging another opening in the vehicle.
